(19) United States
(12) Patent Application Publication
(10) Pub. No.: US 2026/0155040 A1
(43) Pub. Date: Jun. 4, 2026

(54) METHOD, APPARATUS, AND SYSTEM OF ASSESSING IMPACT OF TRAFFIC SPILLOVER

(71) Applicant: HERE GLOBAL B.V., EINDHOVEN (NL)

(72) Inventors: JEROME BEAUREPAIRE, NANTES (FR); AMARNATH NAYAK, MUMBAI (IN)

(73) Assignee: HERE GLOBAL B.V., EINDHOVEN (NL)

(21) Appl. No.: 18/963,801

(22) Filed: Nov. 29, 2024

(51) Int. Cl. G08G 1/01; G06N 20/00

(52) U.S. Cl. CPC G08G 1/0133; G06N 20/00

(57) ABSTRACT

An approach is provided for assessing impact of traffic spillover. The approach, for instance, involves receiving training data indicating events and attributes associated with the events, where the events indicate traffic spillover from routes to regions local to the routes. The approach further involves using the training data to train a machine learning model to predict impact of traffic congestion of a first route on a first region local to the first route based on first attributes associated with the first route. The approach further involves receiving as input the first attributes associated with the first route. The approach further involves causing the machine learning model to predict the impact based on the first attributes and providing the impact as output.

### BACKGROUND

As a number of automobiles increases, traffic congestion inevitably increases, thus creating significant issues within various regions. For example, while traffic congestion is common among densely populated regions, it is also becoming a serious problem in lesser populated regions such as villages, particularly those located near major highways and interstates. This congestion is often caused by a combination of increasing traffic volume on highways and limited infrastructure within the villages themselves.

As traffic on highways becomes congested due to accidents, construction, or peak travel periods, vehicles are frequently diverted onto local roads, leading to a spillover effect. This creates unexpected traffic bottlenecks in nearby villages that are not equipped to handle large volumes of vehicles. In many cases, these villages have narrow roads, limited traffic management systems, and lack the necessary resources to accommodate the influx of cars and trucks, exacerbating the congestion and creating safety hazards for both pedestrians and local drivers.

Additionally, the congestion caused by traffic spillover from highways affects the quality of life in these small communities. Increased vehicle emissions, noise pollution, and delays impact residents' daily routines, hinder local commerce, and cause frustration among travelers and occupants of regions impacted by the traffic spillover. Emergency services, such as ambulances and fire trucks, also face delays, which can result in dangerous situations.

Currently, traffic management solutions such as rerouting, road expansions, or implementing intelligent traffic systems are typically focused on urban centers, leaving rural villages with few options to mitigate the effects of congestion caused by nearby highways. There is a pressing need for innovative traffic management systems that address such specific problem and provide a solution to alleviate traffic congestion in villages located near major highways.

### SOME EXAMPLE EMBODIMENTS

Therefore, there is a need for an approach for a traffic management solution that reduces the impact of traffic congestion from high functional class roads on regions local to the roads and enhances traffic flow in such regions.

According to one embodiment, an apparatus comprising at least one processor and at least one non-transitory memory including computer program code instructions is described. The computer program code instructions are configured to, when executed, cause the apparatus to: receive training data indicating events and attributes associated with the events, wherein the events indicate traffic spillover from routes to regions local to the routes; based on the training data, train a machine learning model to predict impact of traffic congestion of a first route on a first region local to the first route based on first attributes associated with the first route; receive as input the first attributes associated with the first route; cause the machine learning model to predict the impact based on the first attributes; and provide the impact as output.

In some embodiments, a functional class of the first route is greater than a functional class of each road segment within the first region.

In some embodiments, the attributes indicate: (i) one or more types of incidents that caused the traffic spillover from the routes; (ii) locations of the incidents on the routes; (iii) a functional class of a road segment in which each of the incidents occurred; (iv) temporal information associated with the events; (v) traffic congestion of the routes and the regions; (vi) weather condition of the routes; (vii) weather conditions of the regions; or (viii) a combination thereof.

In some embodiments, the impact is defined by: (i) a change in traffic congestion within the first region; and (ii) a duration of which the traffic congestion of the first region will be greater than average traffic congestion of the first region.

In some embodiments, the attributes include air quality index (AQI) values of the regions, and the impact indicates an AQI value of the first region.

In some embodiments, the attributes include noise levels of the regions, and the impact indicates a noise level of the first region.

In some embodiments, the computer program code instructions are configured to, when executed, cause the apparatus to, based on the impact, generate a second route that diverges from the first route and terminates at the same destination as the first route.

According to another embodiment, a non-transitory computer-readable storage medium having computer program code instructions stored therein is described. The computer program code instructions, when executed by at least one processor, cause the at least one processor to: receive training data indicating events and attributes associated with the events, wherein the events indicate traffic spillover from routes to regions local to the routes; based on the training data, train a machine learning model to predict impact of traffic congestion of a first route on a first region local to the first route based on first attributes associated with the first route; receive as input the first attributes associated with the first route; cause the machine learning model to predict the impact based on the first attributes; and provide the impact as output.

According to another embodiment, a method of assessing impact of traffic spillover is described. The method includes: receiving training data indicating events and attributes associated with the events, wherein the events indicate traffic spillover from routes to regions local to the routes; based on the training data, training a machine learning model to predict impact of traffic congestion of a first route on a first region local to the first route based on first attributes associated with the first route; receiving as input the first attributes associated with the first route; causing the machine learning model to predict the impact based on the first attributes; and providing the impact as output.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 illustrates a diagram of a system capable of assessing impact of traffic spillover from routes, according to an embodiment;

FIG. 2 illustrates a diagram of an example scenario of acquiring training data, according to an embodiment;

FIG. 3A illustrates a diagram of training a machine learning model, according to an embodiment;

FIG. 3B illustrates a diagram of the trained machine learning model outputting impact data, according to an embodiment;

FIG. 4 illustrates a diagram of an example user interface displaying information indicating traffic spillover to occupants of a region, according to an embodiment;

FIG. 5 illustrates a diagram of an example user interface displaying information indicating traffic spillover to a driver, according to an embodiment;

FIG. 6 illustrates a flowchart of a process for assessing impact of traffic spillover, according to an embodiment;

FIG. 7 illustrates a diagram of a database, according to an embodiment;

FIG. 8 illustrates a computer system upon which an embodiment of the invention may be implemented;

FIG. 9 illustrates a diagram of a chip set upon which an embodiment of the invention may be implemented; and

FIG. 10 illustrates a diagram of exemplary components of a mobile terminal capable of operating in the system of FIG. 1, according to one embodiment.

### DESCRIPTION OF SOME EMBODIMENTS

Examples of a method, apparatus, and computer program for assessing impact of traffic spillover are disclosed, according to various example embodiments. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

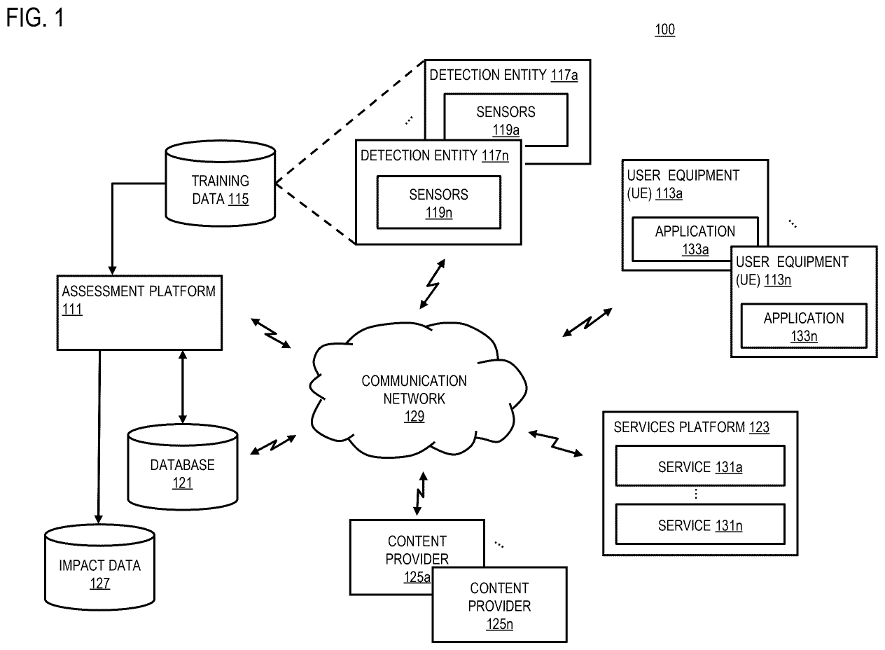

FIG. 1 illustrates a diagram of a system 100 capable of assessing impact of traffic spillover, according to an embodiment. Herein, traffic spillover refers to a situation in which traffic congestion on a route causes drivers to seek alternate routes that bypasses the traffic congestion of the route through nearby roads, such as local roads of a village. Typically, traffic spillover occurs when traffic on a major roadway, such as arterial roads, becomes slow or blocked due to accidents, construction, or high traffic volumes, prompting drivers to divert to lower functional class roads, such as collector roads and local roads, and bypass the traffic congestion on the major roadway. However, such lower functional class roads are often inefficient at handling the high volume of traffic that a major highway can carry, leading to congestion in areas that are usually not as busy. Such spillover can overwhelm small roads, causing delays, increasing the risk of accidents, and negatively affecting the local community by increasing noise, pollution, and travel times.

To mitigate such adverse effects of traffic spillover, an assessment platform 111 of a system 100 may predict impact of traffic congestion of routes on regions local to the routes. In one embodiment, the assessment platform 111 may output information to user devices, such as user equipment (UE) 113a-113n (collectively referred as UE 113), based on the prediction. For example, the assessment platform 111 may output the prediction to user devices of drivers, thereby discouraging drivers from taking alternative routes that go through local roads of a village. By way of another example, the assessment platform 111 may output the prediction to user devices of occupants within regions that are predicted to be impacted by the traffic spillover, thereby enabling the occupants to plan their trips within the village. In one embodiment, the assessment platform 111 may generate and output navigational or vehicle-related maneuver instructions on user devices based on the prediction. For example, if the prediction indicates that traffic congestion of a highway will increase traffic congestion of local roads within a nearby village, the assessment platform 111 may identify an alternative route that bypasses the traffic congestion on the highway and does not go through the village and recommend the route to the user. By way of another example, if the prediction indicates that traffic congestion of a highway will increase traffic congestion of local roads within a nearby village, the assessment platform 111 may output a recommendation suggesting that a driver should stay within the highway until the traffic congestion decreases.

To predict impact of traffic congestion of routes on regions local to the routes, the assessment platform 111 may train a machine learning model to output impact data 127 by using training data 115. Herein, a region local to a route indicates a region that includes at least a portion of an alternative route that diverges from the route. In the illustrated embodiment, the training data 115 may be acquired by one or more detection entities 117a-117n (collectively referred as detection entities 117) equipped with sensors 119a-119n (collectively referred as sensors 119) for acquiring attributes associated with geographic features of regions, physical characteristics of various objects, such as vehicles, roads, etc., and the like. In certain embodiments, portions of the training data 115 may be data acquired from one or more other entities within the system 100, such as database 121, services platform 123, content providers 125a-125n (collectively referred as content providers 125), or a combination thereof.

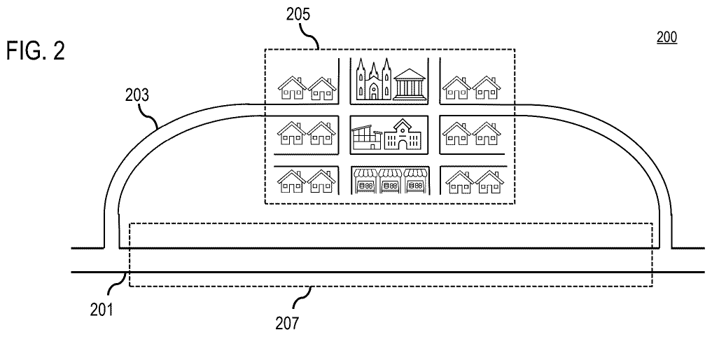

FIG. 2 illustrates a diagram of an example scenario 200 of acquiring training data, according to an embodiment. In the illustrated embodiment, the scenario 200 involves a highway 201, an alternative route 203, and a village 205. The alternative route 203 is connected to the highway 201 at two different points along the highway 201, and a portion of the alternative route 203 resides within the village 205. Since the alternative route 203 provides a path for vehicles between two points along the highway 201, vehicle navigation systems may provide the alternative route 203 as a recommendation if traffic congestion increases within the highway 201, particularly within a portion 207 of the highway 201. Such recommendations may attribute to traffic spillover events, where vehicles on the highway 201 traverse the alternative route 203 to avoid traffic congestion within the portion 207. During such events, one or more detection entities 117, such as vehicles and sensors available within the highway 201, the alternative route 203, the village 205, or a combination thereof, may capture attributes associated with the highway 201, the alternative route 203, the village 205, or the combination thereof and transmit the captured attributes as a part of the training data 115.

The training data 115 may indicate events of traffic spillover from routes to regions local to the routes. In one embodiment, the training data 115 may be provided as one or more datasets, where each of the one or more datasets include a target variable and features. Each dataset may indicate attributes associated with each traffic spillover event.

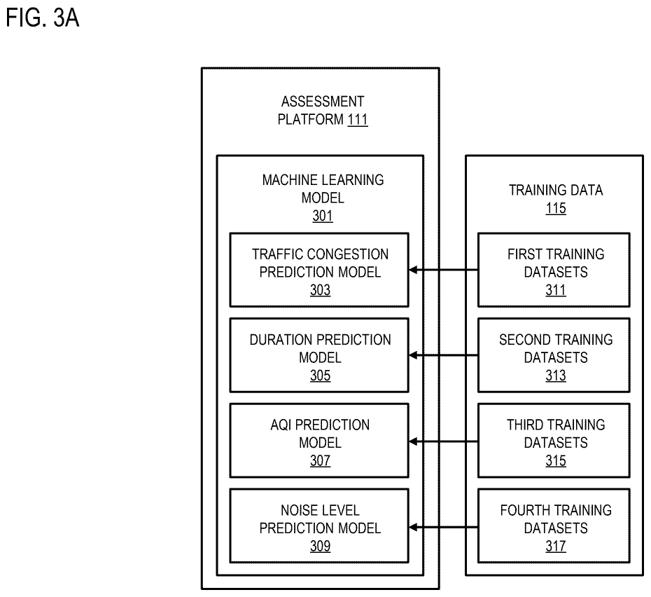

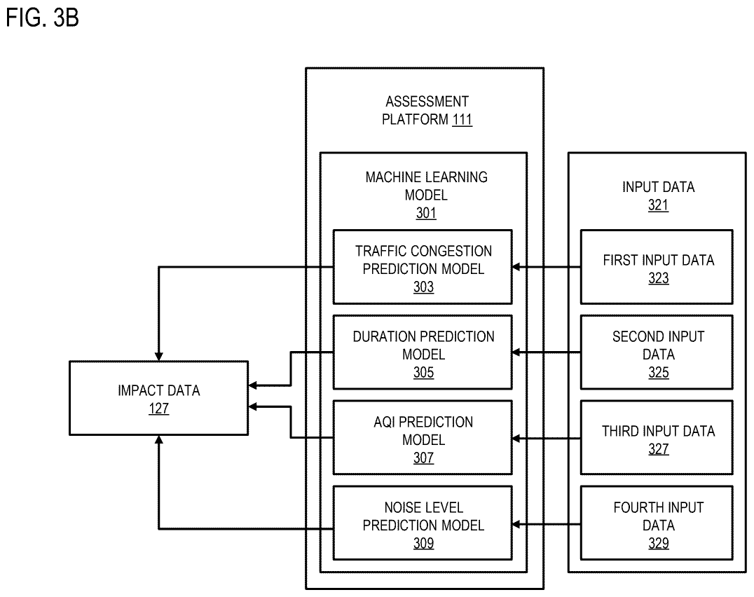

FIG. 3A illustrates a diagram of training a machine learning model, according to an embodiment. In the illustrated embodiment, the assessment platform 111 includes a machine learning model 301. The machine learning model 301 may receive the training data 115 as input, and the training data 115 may be used to train the machine learning model 301 to predict impact of traffic congestion of a route on a region local to the route. In one embodiment, the machine learning model 301 includes a traffic congestion prediction model 303, a duration prediction model 305, an AQI prediction model 307, and a noise level prediction model 309. In one embodiment, each of the traffic congestion prediction model 303, the duration prediction model 305, the AQI prediction model 307, and the noise level prediction model 309 may be a supervised machine learning model. For example, the supervised machine learning model may be a regression model, such as Linear Regression, Polynomial Regression, Support Vector Regression (SVR), and Decision Tree Regression.

In the illustrated embodiment, the training data 115 includes first training datasets 311, second training datasets 313, third training datasets 315, and fourth training datasets 317. Each of the training datasets includes a pair of a target variable and one or more features associated with the target variable.

In one embodiment, each of the first training datasets 311 includes a target variable indicating a change in traffic congestion measured as a change in an estimated time of arrival (ETA) in a region impacted by traffic spillover and one or more features indicating: (i) a type of incident on a route that caused traffic spillover (e.g., accident, roadworks, broken down vehicles, etc.); (ii) a location of the incident on the route; (iii) a functional class of a road segment in which the incident occurred; (iv) temporal information associated with the traffic spillover (e.g., hour of the day, month of the day, holiday or non-holiday, weekend, weekday, etc.); (v) traffic congestion of the route; (vi) weather condition of the route (e.g., temperature, humidity, etc.); (vii) weather conditions of the region; or (viii) a combination thereof. The first training datasets 311 may be input to the traffic congestion prediction model 303, and using the first training datasets 311, the traffic congestion prediction model 303 may be trained to predict a change in traffic congestion in a region impacted by traffic spillover.

In one embodiment, each of the second training datasets 313 includes a target variable indicating a duration for which traffic congestion at a region impacted by traffic spillover is greater than average traffic congestion for the region and one or more features indicating: (i) a type of incident on a route that caused traffic spillover; (ii) a location of the incident on the route; (iii) a functional class of a road segment in which the incident occurred; (iv) temporal information associated with the traffic spillover; (v) traffic congestion of the route; (vi) weather condition of the route; (vii) weather conditions of the region; or (viii) a combination thereof. The second training datasets 313 may be input to the duration prediction model 305, and using the second training datasets 313, the duration prediction model 305 may be trained to predict a duration for which traffic congestion at a region impacted by traffic spillover is greater than average traffic congestion for the region.

In one embodiment, each of the third training datasets 315 includes a target variable indicating an air quality index (AQI) value of a region impacted by traffic spillover and one or more features indicating: (i) a type of incident on a route that caused traffic spillover; (ii) a location of the incident on the route; (iii) a functional class of a road segment in which the incident occurred; (iv) temporal information associated with the traffic spillover; (v) traffic congestion of the route; (vi) weather condition of the route; (vii) weather conditions of the region; (viii) a change in traffic congestion measured as a change in an ETA in the region; (ix) a duration for which traffic congestion at the region is greater than average traffic congestion for the region; or (x) a combination thereof. The third training datasets 315 may be input to the AQI prediction model 307, and using the third training datasets 315, the AQI prediction model 307 may be trained to predict an AQI value of a region impacted by traffic spillover.

In one embodiment, each of the fourth training datasets 317 includes a target variable indicating a noise level (measured in decibel) of a region impacted by traffic spillover and one or more features indicating: (i) a type of incident on a route that caused traffic spillover; (ii) a location of the incident on the route; (iii) a functional class of a road segment in which the incident occurred; (iv) temporal information associated with the traffic spillover; (v) traffic congestion of the route; (vi) weather condition of the route; (vii) weather conditions of the region; (viii) a change in traffic congestion measured as a change in an ETA in the region; (ix) a duration for which traffic congestion at the region is greater than average traffic congestion for the region; or (x) a combination thereof. The fourth training datasets 317 may be input to the noise level prediction model 309, and using the fourth training datasets 317, the noise level prediction model 309 may be trained to predict a noise level of a region impacted by traffic spillover.

FIG. 3B illustrates a diagram of the trained machine learning model 301 outputting impact data, according to an embodiment. In the illustrated embodiment, the machine learning model 301 is trained based on the training data 115 and outputs the impact data 127 as a function of input data 321. The input data 321 indicates, at least, one or more attributes associated with one or more road segments of a route. In some embodiments, the input data 321 may further indicate one or more attributes associated with one or more regions local to the one or more road segments. In one embodiment, the input data 321 may be acquired by the assessment platform 111 when a user input is provided (e.g., a user input received at the UE 113). In one embodiment, the assessment platform 111 may acquire the input data 321 when a system, such as a navigation device (e.g., the UE 113), calculates a route for a user. The assessment platform 111 may acquire the input data 321 from vehicles, sensors, database, or a combination thereof available within a road network. For example, one or more detection entities 117 within a road segment may provide information indicating attributes of the road segment or one or more incidents within the road segment.

In one embodiment, the input data 321 includes first input data 323 corresponding to the first training datasets 311. For example, the first input data 323 may include one or more features indicating: (i) a type of incident on a route (e.g., accident, roadworks, broken down vehicles, etc.); (ii) a location of the incident on the route; (iii) a functional class of a road segment in which the incident occurred; (iv) temporal information (e.g., hour of the day, month of the day, holiday or non-holiday, weekend, weekday, etc.); (v) traffic congestion of the route; (vi) weather condition of the route; (vii) weather conditions of a region local to the route; or (viii) a combination thereof. The first input data 323 may be provided to the trained traffic congestion prediction model 303 as input, and in response, the trained traffic congestion prediction model 303 may output a value indicating a change in traffic congestion measured as a change in an ETA in the region local to the route as a part of the impact data 127.

In one embodiment, the input data 321 includes second input data 325 corresponding to the second training datasets 313. For example, the second input data 325 may include one or more features indicating: (i) a type of incident on a route; (ii) a location of the incident on the route; (iii) a functional class of a road segment in which the incident occurred; (iv) temporal information; (v) traffic congestion of the route; (vi) weather condition of the route; (vii) weather conditions of a region local to the route; or (viii) a combination thereof. The second input data 325 may be provided to the trained duration prediction model 305 as input, and in response, the trained duration prediction model 305 may output a value indicating a duration for which traffic congestion at the region is greater than average traffic congestion for the region as a part of the impact data 127.

In one embodiment, the input data 321 includes a third input data 327 corresponding to the third training datasets 315. For example, the third input data 327 may include one or more features indicating: (i) a type of incident on a route; (ii) a location of the incident on the route; (iii) a functional class of a road segment in which the incident occurred; (iv) temporal information; (v) traffic congestion of the route; (vi) weather condition of the route; (vii) weather conditions of a region local to the route; (viii) a change in traffic congestion measured as a change in an ETA in the region; (ix) a duration for which traffic congestion at the region is greater than average traffic congestion for the region; or (x) a combination thereof. The third input data 327 may be provided to the trained AQI prediction model 307 as input, and the trained AQI prediction model 307 may output an AQI value of the region as a part of the impact data 127.

In one embodiment, the input data 321 includes a fourth input data 329 corresponding to the fourth training datasets 317. For example, the fourth input data 329 may include one or more features indicating: (i) a type of incident on a route; (ii) a location of the incident on the route; (iii) a functional class of a road segment in which the incident occurred; (iv) temporal information; (v) traffic congestion of the route; (vi) weather condition of the route; (vii) weather conditions of a region local to the route; (viii) a change in traffic congestion measured as a change in an ETA in the region; (ix) a duration for which traffic congestion at the region is greater than average traffic congestion for the region; or (x) a combination thereof. The fourth input data 329 may be provided to the trained noise level prediction model 309 as input, and the trained noise level prediction model 309 may outputs a noise level of the region as a part of the impact data 127.

The machine learning model 301 outputs the impact data 127 indicating impact of traffic spillover of a route on a region local to the route. In one embodiment, the impact data 127 includes an impact score, which may be represented as Equation 1, which is presented below:

$$IS = p 1 * w 1 + p 2 * w 2 + p 3 * w 3 + p 4 * w 4 \qquad [ Equation 1 ]$$

In Equation 2 IS is the impact score, p1 is a value indicating a change in traffic congestion measured as a change in an ETA in a region local to a route (i.e., the output of the traffic congestion prediction model 303), p2 is a value indicating a duration for which traffic congestion at the region is greater than average traffic congestion for the region (i.e., the output of the duration prediction model 305), p3 is an AQI value of a region local to a route (i.e., the output of the AQI prediction model 307), p4 is a noise level of a region local to a route (i.e., the output of the noise level prediction model 309), w1 is a weight of p1, w2 is a weight of p2, w3 is a weight of p3, and w4 is a weight of p4. In one embodiment, the weights w1, w2, w3, and w4 may be equal to each other. In alternative embodiments, the weights w1, w2, w3, and w4 may be different from each other. For example, the weights w1 and w2 may be greater than the weights w3 and w4, as increase in traffic congestion of a region may attribute to increase in an AQI value and a noise level of the region.

The impact score may be used to trigger various applications for addressing traffic spillover. In one embodiment, the assessment platform 111 may compare the impact score as indicated in the impact score against a threshold value, and if the impact score exceeds a threshold value, the assessment platform 111 may provide an application addressing traffic spillover. For example, the impact score may be a value from a range of 0 to 1, where the value 0 indicates absence of impact of traffic spillover on a region local to a route, the value 1 indicates presence of impact of traffic spillover on the region, and the value between 0 and 1 indicates a likelihood of impact of traffic spillover within the region. In one example, the threshold value may be 0.6, and if the impact score exceeds 0.6, the assessment platform 111 may provide an application for addressing traffic spillover. While the current embodiment defines the impact score as a combination of the values p1, p2, p3, and p4 and the weights w1, w2, w3, and w4, the impact score may be defined as a different combination of one or more of the values p1, p2, p3, and p4 and one or more of the weights w1, w2, w3, and w4 in alternative embodiments. For example, in one embodiment, the impact score may be defined as p1*w1+p2*w2, and if the impact score satisfies a threshold, the assessment platform 111 may provide an application for addressing traffic spillover.

In one embodiment, impact of traffic spillover of a route on a region local to the route may be determined based on vehicle-related accidents or traffic violations within the region. For example, the impact may be determined based on a number of vehicle-related accidents within the region, the severity of the vehicle-related accidents, a number of traffic violations within the region, the severity of the traffic violations, or a combination thereof. In one embodiment, the machine learning model 301 may be trained based on training data including datasets indicating events of traffic spillover within a region, vehicle-related accidents within the region, and traffic violations within the region and attributes associated with the events. For example, a dataset may indicate a target variable indicating a number of vehicle-related accidents within a region impacted by traffic spillover and one or more features indicating: (i) a type of incident on a route that caused the traffic spillover; (ii) a location of the incident on the route; (iii) a functional class of a road segment in which the incident occurred; (iv) temporal information associated with the traffic spillover; (v) traffic congestion of the route; (vi) weather condition of the route; (vii) weather conditions of the region; or (viii) a combination thereof. Once trained, the machine learning model 301 may output values indicating vehicle-related accidents or traffic violations within the region as a function of input data corresponding to the training data, and the outputted values may attribute to the impact score.

In one embodiment, impact of traffic spillover of a route on a region local to the route may be determined based on additional factors, such as changes within day-to-day functions within the region. For example, the impact may be determined based on how the traffic spillover affects times for picking up children from schools within the region, comfort and convenience of travel within the region (e.g., walking, using public transport, using bikes, using micromobility vehicles, using electric wheelchairs, etc.), and trips to various points of interest (POIs) within the region (e.g., hospitals, stores, office buildings, etc.). In one embodiment, the machine learning model 301 may be trained based on training data including datasets indicating events in which traffic spillover impacted day-to-day functions within the region and attributes associated with the events. For example, a dataset may include a target variable indicating a time at which children were picked up from a school within a region impacted by traffic spillover and one or more features indicating: (i) a type of incident on a route that caused the traffic spillover; (ii) a location of the incident on the route; (iii) a functional class of a road segment in which the incident occurred; (iv) temporal information associated with the traffic spillover; (v) traffic congestion of the route; (vi) weather condition of the route; (vii) weather conditions of the region; or (viii) a combination thereof. Once trained, the machine learning model 301 may output values indicating the day-to-day functions within the region based on input data corresponding to the training data. The outputted values may be compared with mobility patterns of occupants within the region. A mobility pattern refers to the regular or repeated movement behaviors of individuals, groups, or populations within a certain space over time. A mobility pattern captures how people move from one place to another in their daily lives or in response to various factors like work, social activities, or environmental changes. As such, differences between the outputted values and the mobility patterns may attribute to the impact score. For example, the machine learning model 301 may output a predicted time at which children will be picked up from school within a region, and mobility patterns of the region may indicate that children are typically picked up from the school at a different time. In such example, the difference between the predicted time and the time as indicated in the mobility patterns may be used to determine the impact score.

In one embodiment, applications for addressing traffic spillover include outputting information regarding traffic spillover to occupants within a region that is predicted to be impacted by traffic spillover. In one embodiment, such information may be output to one or more user equipment, such as the UE 113. In one embodiment, the information may indicate that traffic congestion within the region is predicted to increase due to traffic spillover from a route local to the region. In one embodiment, the information may indicate a duration and severity of the traffic congestion within the region. In one embodiment, the assessment platform 111 may selectively provide information regarding traffic spillover to occupants within a region based on mobility patterns of the occupants. For example, an output of the machine learning model 301 may indicate an increase in traffic congestion within a village during a certain duration, and a mobility pattern of an occupant may indicate that the occupant historically moves from location A to location B within the village during said duration. In such example, the assessment platform 111 may output information regarding impact of traffic spillover on the village to the occupant and refrain from providing such information to other occupants within the village that do not typically move from location A to location B during said duration.

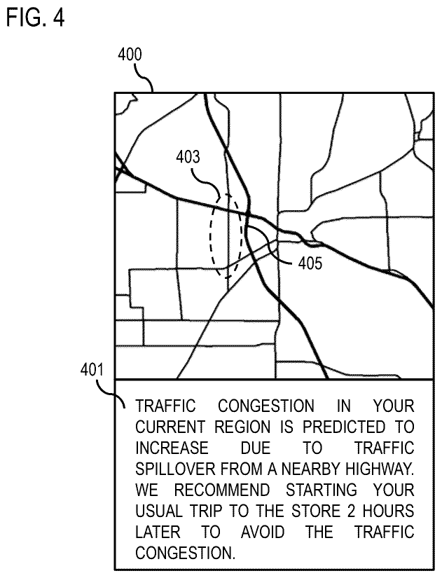

FIG. 4 illustrates a diagram of an example user interface 400 displaying information indicating traffic spillover to occupants of a region, according to an embodiment. In the illustrated example, the assessment platform 111 learns that a user typically goes to a store within a region 403 around 1 PM based on the mobility pattern of the user. Additionally, the machine learning model 301 outputs a prediction indicating that traffic congestion of the region 403 will increase at 1 PM due to traffic spillover from a highway 405. The assessment platform 111 further determines that the traffic congestion within the region 403 will decrease around 3 PM. As such, the assessment platform 111 causes a user equipment of the user to display the user interface 400 including information 401 stating “TRAFFIC CONGESTION IN YOUR CURRENT REGION IS PREDICTED TO INCREASE DUE TO TRAFFIC SPILLOVER FROM A NEARBY HIGHWAY. WE RECOMMEND STARTING YOUR USUAL TRIP TO THE STORE 2 HOURS LATER TO AVOID THE TRAFFIC CONGESTION.”

In one embodiment, the assessment platform 111 may determine a direction of travel of an individual (e.g., via movement of the individual's mobile device or vehicle). If the direction of travel indicates that the individual is moving towards a region that is predicted to be impacted by traffic spillover, the assessment platform 111 may refrain from providing information regarding traffic spillover to the individual's mobile device, as the individual is likely to experience increasing traffic congestion as the individual moves towards the region, thus rendering the information irrelevant. In one embodiment, the assessment platform 111 may provide the information to billboards, road signs, or any structures capable of publicly displaying information that are within the regions, thereby informing occupants of the regions regarding the traffic spillover.

In one embodiment, applications for addressing traffic spillover include outputting information regarding traffic spillover to drivers within routes in which traffic spillover is predicted occur or drivers that are planning to traverse the routes. In one embodiment, the information provided to the drivers include prediction of how the traffic spillover will impact regions local to the routes (e.g., by presenting an amount predicted increase in traffic congestion in a region, a predicted increase in AQI value for the region, a predicted increase in noise level for the region, a predicted increase in vehicle-related accidents, a predicted increase in school pick-up times, etc.), thereby deterring drivers from traversing alternative routes that go through the regions and mitigating adverse impacts on occupants within the region. In one embodiment, the information provided to the drivers include amounts of ETA saved if the drivers traverse the alternative routes. For example, a driver may be deterred from embarking the alternative route if the amount of ETA saved by traversing the alternative route is not significant (e.g., ETA saved on the alternative route is only 3 minutes).

In one embodiment, applications for addressing traffic spillover include providing a “village friendly routing” option. In such embodiment, the “village friendly routing” option is available to drivers and may be enabled via a user equipment, such as the UE 113. When such option is enabled, the assessment platform 111 may provide information regarding traffic spillover to drivers within routes in which traffic spillover is predicted occur or drivers that are planning to traverse the routes. Such information includes the impact score, information on how the traffic spillover will impact regions local to the routes, and information indicating amounts of ETA saved if the drivers choose to embark alternative routes that diverge from the routes and go through the regions. In one embodiment, the information regarding traffic spillover is provided to a driver if a difference between the amount of ETA saved from embarking the alternative route and the amount of ETA for traversing the current route of the driver is greater than a threshold difference (e.g., 20 percent).

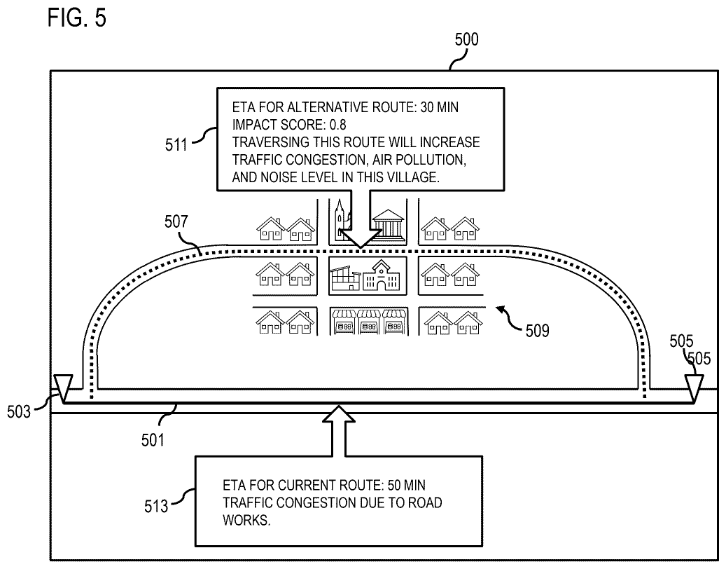

For example, FIG. 5 illustrates a diagram of an example user interface 500 displaying information indicating traffic spillover to a driver, according to an embodiment. In the illustrated embodiment, a driver has enabled the “village friendly routing” option on the driver's navigation device, such as the UE 113. The assessment platform 111 has determined that an ETA for the current route 501 from a starting location 503 to a destination 505 is 50 minutes due to road works causing traffic congestion within the current route 501. The assessment platform 111 has further determined that an ETA for an alternative route 507 from the starting location 503 to the destination 505 is 30 minutes. In the illustrated embodiment, the alternative route 507 goes through a village 509. The assessment platform 111 has further determined that the impact score for the village 509 is 0.8 and predicted that vehicles traversing the alternative route 507 will increase traffic congestion, air pollution, and noise level in the village 509. To enable the driver to assess routing options, the user interface 500 includes first information 511 stating “ETA FOR ALTERNATIVE ROUTE: 30 MIN,” “IMPACT SCORE: 0.8,” and “TRAVERSING THIS ROUTE WILL INCREASE TRAFFIC CONGESTION, AIR POLLUTION, AND NOISE LEVEL IN THIS VILLAGE” and second information 513 stating “ETA FOR CURRENT ROUTE: 50 MIN” and “TRAFFIC CONGESTION DUE TO ROAD WORKS.”

In one embodiment, if a traffic spillover occurs on a route, the assessment platform 111 may determine whether the route includes multiple alternative routes that diverge from the route and terminate at the same destination as the route. In such embodiment, the assessment platform 111 determines the impact score for each of the alternative routes and selects an alternative route among the alternative routes that is associated with the lowest impact score and outputs the selected alternative route to drivers on the route as a recommendation.

In one embodiment, the impact score may be calculated for various regions, and the assessment platform 111 may establish various graphical indicators on a map to indicate the severity of the impact score for each of the regions. In one embodiment, a graphic indicator may be established to indicate each of a value indicating a change in traffic congestion measured as a change in an ETA in a region local to a route (i.e., the output of the traffic congestion prediction model 303), a value indicating a duration for which traffic congestion at the region is greater than average traffic congestion for the region (i.e., the output of the duration prediction model 305), an AQI value of a region local to a route (i.e., the output of the AQI prediction model 307), and a noise level of a region local to a route (i.e., the output of the noise level prediction model 309). The graphical indicators may be represented as concentric circles, heatmaps, or other graphic means to establish the impact score for each of the various regions.

In one embodiment, the assessment platform 111 may provide routing options for drivers based on the impact scores of regions and attributes of the drivers' vehicles. In such embodiment, if the impact score for a region exceeds a threshold, the assessment platform 111 may provide an alternative route that goes through the region as a routing option for a driver based on the attributes of the driver's vehicle.

For example, if the attributes indicate that the vehicle does not contribute to adverse impact on its environment (e.g., the vehicle is an electric vehicle, the vehicle is a hydrogen vehicle, the vehicle is a hybrid vehicle, the vehicle does not generate a substantial amount of emission, the vehicle does not generate excessive noise, etc.), the assessment platform 111 may provide the alternative route as a routing option for the driver.

By way of another example, if the attributes indicate that the vehicle is a ride-sharing vehicle, the assessment platform 111 may provide the alternative route as a routing option for the driver. In such example, the alternative route is presented to the ride-sharing vehicle to increase opportunities for ride-sharing services within regions where ride-sharing services are typically scarce or unavailable.

By way of another example, if the attributes indicate that the vehicle includes one or more Advance Driver Assistance System (ADAS) features, the assessment platform 111 may provide the alternative route as a routing option for the driver. In such example, said one or more ADAS features include: (i) a feature that limits a vehicle's maximum speed and/or acceleration; (ii) a feature that prevents overtaking; (iii) a feature that prevents use of mobile devices or other user interfaces within the vehicle; (iv) a feature that automatically adjusts the vehicle's speed to maintain a safe distance with a vehicle in front of the vehicle (e.g., Adaptive Cruise Control); (v) a feature that detects an impending crash with an object and automatically activates braking based on the detection (e.g., Automatic Emergency Braking); (vi) a feature that prevents unintentional lane departures (e.g., Lane Keeping Assist); (vii) a feature that alerts the driver when the vehicle moves out of its lane (e.g., Lane Departure Warning); (viii) a feature that uses cameras to detect and read road signs and displays the detected information to the driver (e.g., Traffic Sign Recognition); (ix) a feature that provides alerts for detecting vehicles in blind spots (e.g., Blind Spot Detection); (x) a feature that warns the driver of approaching traffic from both sides of the vehicle when the vehicle is reversing out of a parking space (e.g., Rear Cross Traffic Alert); (xi) a feature that assists the vehicle in parking (e.g., Parking Assistance System); (xii) a feature that warns the driver of an imminent collision with an object in front of the vehicle (e.g., Forward Collision Warning); (xiii) a feature that monitors the driver's attentiveness and provides alerts in response to signs of fatigue or distraction (e.g., Driver Monitoring System); (xiv) a feature that helps the driver see beyond the range of the vehicle headlights by using infrared or thermal imaging technology (e.g., Night Vision); a feature that projects information onto the vehicle's windshield along the driver's line of sight (e.g., Head-up Display); or a combination thereof.

In one embodiment, if the impact score exceeds a threshold, the assessment platform 111 may provide an alternative route that goes through a region predicted to be impacted by traffic spillover as a routing option for autonomous vehicles. In one embodiment, If the impact score exceeds a threshold, the assessment platform 111 may provide the alternative route as a routing option for autonomous vehicle based on attributes of the autonomous vehicle. For example, the assessment platform 111 may provide the alternative route to the autonomous vehicle based on: (i) a type of autonomous vehicle (e.g., electric vehicle, a hybrid vehicle, or a hydron vehicle, etc.); (ii) features of the autonomous vehicle; (iii) objects carried within the autonomous vehicle (e.g., people, items); or (iv) a combination thereof. In one embodiment, the assessment platform 111 may provide control signals including maneuver instructions for autonomous vehicles and make decisions on whether the autonomous vehicles are allowed to traverse through alternative routes that go through regions predicted to be impacted by traffic spillover.

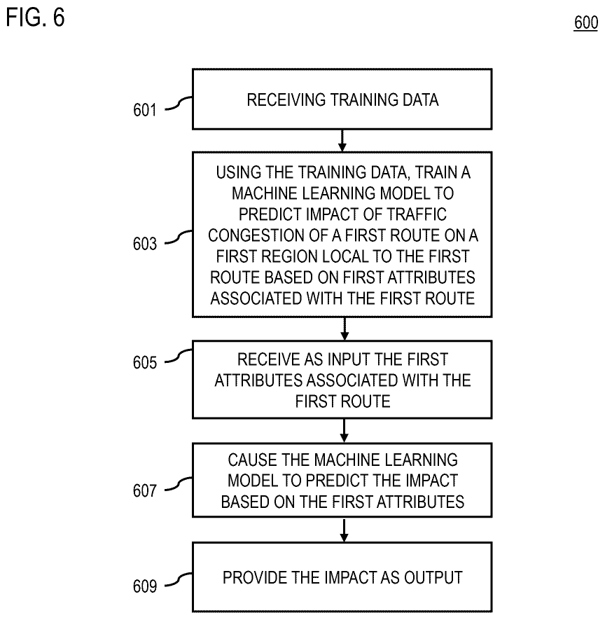

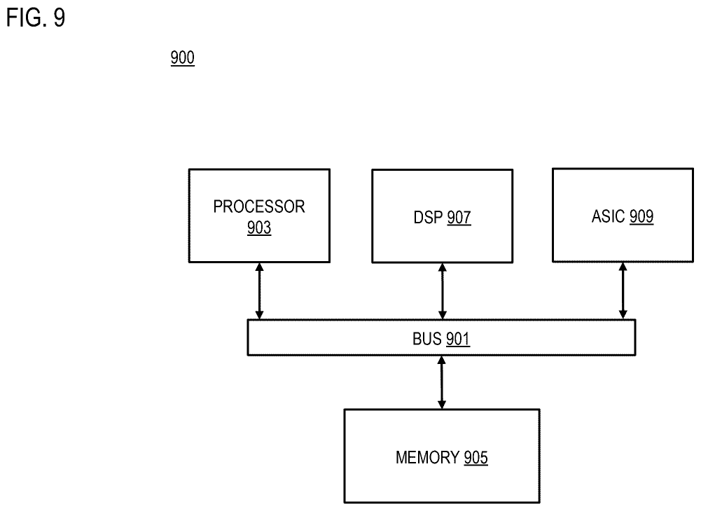

FIG. 6 is flowchart of a process for assessing impact of traffic spillover, according to an embodiment. In various embodiments, the assessment platform 111 may perform one or more portions of the process 600 and may be implemented in, for instance, a chip set including a processor and a memory as shown in FIG. 9. As such, the mapping platform 115 can provide means for accomplishing various parts of the process 600, as well as means for accomplishing embodiments of other processes described herein in conjunction with other components of the system 100. Although the process 600 is illustrated and described as a sequence of steps, it is contemplated that various embodiments of the process 600 may be performed in any order or combination and need not include all of the illustrated steps. Herein, the process 600 will be described in conjunction with FIGS. 1, 3A and 3B.

In step 601, the assessment platform 111 receives the training data 115. In one embodiment, the training data 115 may be provided by one or more detection entities 117, one or more other entities within the system 100, such as the database 121, the services platform 123, the content providers 125, or a combination thereof. The training data 115 may indicate events of traffic spillover from routes to regions local to the routes. In one embodiment, the training data 115 may be provided as one or more datasets, where each of the one or more datasets include a target variable and one or more features. A target variable may be: (i) a change in traffic congestion within a region; (ii) a duration of which traffic congestion of the region is greater than average traffic congestion of the region; (iii) an AQI value of the region; (iv) a noise level of the region; or (v) a combination thereof. Each dataset may indicate the one or more features as one or more attributes associated with each traffic spillover event. In one embodiment, the one or more attributes indicate: (i) a type of incident that caused the traffic spillover from a route; (ii) a location of the incident on the route; (iii) a functional class of a road segment in which the incident occurred; (iv) temporal information associated with a traffic spillover event; (v) traffic congestion of the route and a region impacted by traffic spillover of the route; (vi) weather condition of the route; (vii) weather condition of the region; (viii) a change in traffic congestion within the region; (ix) a duration of which traffic congestion of the region is greater than average traffic congestion of the region; or (x) a combination thereof.

In step 603, the assessment platform 111 uses the training data 115 to train the machine learning model 301 to predict impact of traffic congestion of a first route on a first region local to the first route based on first attributes associated with the first route. In one embodiment, the impact may include an impact score. In one embodiment, the impact is defined by: (i) a change in traffic congestion within the first region; (ii) a duration of which the traffic congestion of the first region will be greater than average traffic congestion of the first region; (iii) an AQI value of the first region; (iv) a noise level of the first region; or (v) a combination thereof. In one embodiment, the first route may be a route of interest (e.g., as indicated in the input data 321), the first region may be a region of interest (e.g., as indicated in the input data 321), and the first attributes may be attributes of interest (e.g., as indicated in the input data 321). The assessment platform 111 may feed the machine learning model 301 the one or more datasets as indicated in the training data 115, and the machine learning model 301 may analyze the data to identify patterns and relationships between inputs and outputs. The machine learning model 301 may minimize the difference between the model's predictions and the actual labels by adjusting the model's parameters. In one embodiment, the machine learning model 301 may be a supervised machine learning model. For example, the supervised machine learning model may be a regression model, such as Linear Regression, Polynomial Regression, Support Vector Regression (SVR), and Decision Tree Regression.

In step 605, the assessment platform 111 receives as input the first attributes associated with the first route. For example, once the machine learning model 301 is trained, the assessment platform 111 may receive the first attributes associated with the first route as the input data 321 and provide the input data 321 to the machine learning model 301. In one embodiment, the input data 321 indicates, at least, one or more attributes associated with one or more road segments of a route. In some embodiments, the input data 321 may further indicate one or more attributes associated with one or more regions local to the one or more road segments. In one embodiment, the input data 321 may be acquired by the assessment platform 111 when a user input is received at a user equipment (e.g., a user input received at the UE 113). In one embodiment, the assessment platform 111 may acquire the input data 321 when a system, such as a navigation device (e.g., the UE 113), calculates a route for a user. In one embodiment, the assessment platform 111 may acquire the input data 321 from vehicles, sensors, database, or a combination thereof available within a road network. For example, one or more detection entities 117 within a road segment may provide information indicating attributes of the road segment or one or more incidents within the road segment. In one embodiment, the input data 321 corresponds to the training data 115. For example, the first attributes as indicated in the input data 321 may correspond to the features of the datasets of the training data 115.

In step 607, the assessment platform 111 causes the machine learning model 301 to predict the impact based on the first attributes. The trained machine learning model 301 analyzes the first attributes to identify patterns and relationships between inputs and outputs as learned through the training data 115 and outputs the impact as a function of the first attributes. As discussed above, the impact may be provided as the impact score.

In step 609, the assessment platform 111 provides the impact as output. In one embodiment, the output may be an application for addressing traffic spillover. For example, the assessment platform 111 may output information indicating the impact on a user equipment (e.g., the UE 113). In one embodiment, the information indicating the impact may be provided to user equipment of occupants within the first region, a driver traversing the first route, or a combination thereof.

Returning to FIG. 1, as shown and discussed above, the system 100 includes the assessment platform 111 for addressing traffic spillover, according to an embodiment of the invention. In one embodiment, the assessment platform 111 has connectivity or access to one or more databases for storing the impact data 127 determined according to the various embodiments described herein, and as well as a database 121 for retrieving mapping data and/or related attributes for outputting the impact data 127. In one embodiment, the database 121 can include electronic or digital representations routes that regions impacted by traffic spillover and regions predicted to be impacted by traffic spillover.

In the illustrated embodiment, the UE 113 has connectivity to the assessment platform 111 via the communication network 129. The UE 113 may be any type of mobile terminal or fixed terminal such as a mobile handset, station, unit, device, multimedia computer, multimedia tablet, Internet node, communicator, cellular telephone, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, devices associated with or integrated with a vehicle (e.g., as part of an infotainment system), or any combination thereof, including the accessories and peripherals of these devices. In one embodiment, the UE 113 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the UE 113 may support any type of interface to the user (such as “wearable” devices, etc.).

In the illustrated embodiment, applications 133a-133n (collectively referred as applications 133) may be executable by the UE 113 to provide one or more applications related to the impact data 127. In one embodiment, the application 133 may cause user interface of the UE 113 to present a map including one or more regions predicted to be impacted by traffic spillover, an impact score associated with each of the one or more regions, predicted traffic congestion for each of the one or more regions, predicted AQI value of each of the one or more regions, predicted noise level of each of the one or more regions, etc. In one embodiment, the applications 133 may be other applications executable by the UE 113, such as a mapping application, a location-based service application, a navigation application, a content provisioning service, a camera/imaging application, a media player application, a social networking application, a calendar application, or any combination thereof. In one embodiment, the applications 133 may act as clients for the assessment platform 111 and perform one or more functions associated with the functions of the assessment platform 111 by interacting with the assessment platform 111 over the communication network 129.

In the illustrated embodiment, the detection entities 117 may be vehicles, drones, user equipment, and/or road-side sensors. In the illustrated embodiment, the detection entities 117 include sensors 119a-119n (collectively referred as sensors 119). The sensors 119 may be electronic imaging devices of both analog and digital types, which include digital cameras, camera modules, camera phones, thermal imaging devices, radar, sonar, lidar, etc. The detection entity 117 may further include a network detection sensor for detecting wireless signals or receivers for different short-range communications (e.g., Bluetooth, Wi-Fi, Li-Fi, near field communication (NFC), etc.), temporal information sensors, an audio recorder for gathering audio data, velocity sensors, light sensors, oriental sensors augmented with height sensor and acceleration sensor, tilt sensors to detect the degree of incline or decline of a detection entity 117 along a path of travel, etc. In one embodiment, the sensors 119 may include one or more sensors disposed around the perimeter of a detection entity 117, and said one or more sensors may detect the relative distance of the detection entity 117 from road objects, lanes, or roadways, the presence of other vehicles, pedestrians, traffic lights, road features (e.g., curves) and any other objects, or a combination thereof. In one embodiment, the sensors 119 may also detect orientations of objects. In one embodiment, the detection entities 117 may include GPS receivers to obtain geographic coordinates from satellites for determining current locations associated with the detection entities 117. The detection entities 117 may determine such locations by using a triangulation system such as A-GPS, Cell of Origin, or other location extrapolation technologies. The detection entities 117 may further include receivers/transmitters for maintaining communication with the assessment platform 111 and/or other components within the system 100.

In one embodiment, the assessment platform 111 has connectivity over a communication network 129 to the services platform 123 that provides one or more services 131a-131n (collectively referred as services 131). By way of example, the services 131 may be third-party services that rely on location-based services created or developed based on the impact data 127 generated according to the various embodiments described herein. By way of example, the services 131 include, but are not limited to, autonomous/semi-autonomous vehicle operation, mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 131 uses the output of the assessment platform 111.

In one embodiment, the assessment platform 111 may be a platform with multiple interconnected components. The assessment platform 113 may include multiple servers, intelligent networking devices, computing devices, components, and corresponding software for automated detection and/or characterization of road intersections. In addition, it is noted that the assessment platform 111 may be a separate entity of the system 100, a part of the one or more services 131, a part of the services platform 123, or included within the UE 113.

In one embodiment, content providers 125 may provide content or data (e.g., training data 115, etc.) to the assessment platform 111, the services platform 123, the services 131 and/or the UE 113. The content provided may also include any type of content, lane level road topology data, sensor data, map content, textual content, audio content, video content, image content, etc. used for map matching. In one embodiment, the content providers 125 may also store content associated with the assessment platform 111, the database 121, the services platform 123, the services 131, and/or the UE 113. In another embodiment, the content providers 125 may manage access to a central repository of data, and offer a consistent, standard interface to data, such as a repository of the database 121.

In one embodiment, the communication network 129 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), 5G New Radio Networks, Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the assessment platform 111, UE 113, services platform 123, services 131, and/or content providers 125 optionally communicate with each other and other components of the system 100 using well known, new or still developing protocols. In this context, a protocol includes a set of rules defining how the network nodes within the communication network 123 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

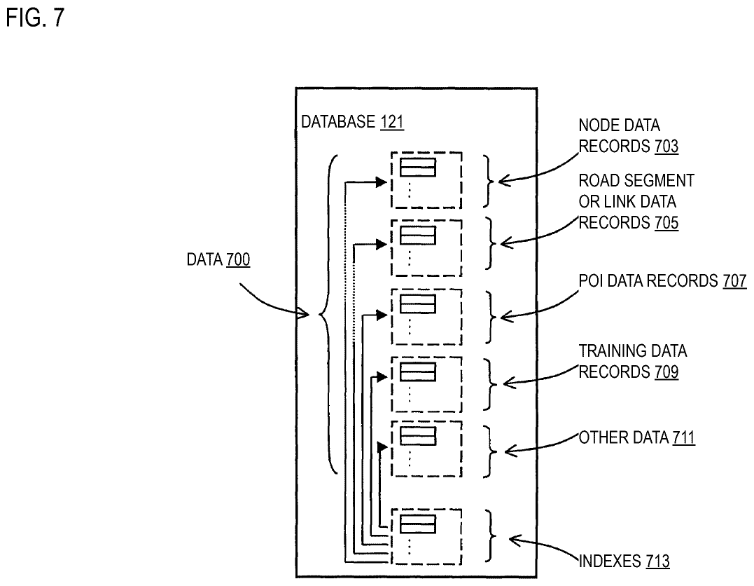

FIG. 7 is a diagram of the database 121, according to an embodiment. In one embodiment, the database 121 includes data 700 used for (or configured to be compiled to be used for) mapping and/or navigation-related services. In one embodiment, the database 121 includes geographic features (e.g., two-dimensional or three-dimensional features) represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the database 121.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the database 121 follows certain conventions. For example, links do not cross themselves and do not cross each other except at a node. Also, there are no duplicated shape points, nodes, or links. Two links that connect each other have a common node. In the database 121, overlapping geographic features are represented by overlapping polygons. When polygons overlap, the boundary of one polygon crosses the boundary of the other polygon. In the database 121, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the database 121 includes node data records 703, road segment or link data records 705, POI data records 707, training data records 709, other data 711, and indexes 713, for example. More, fewer, or different data records can be provided. In one embodiment, additional data records (not shown) can include cartographic (“carto”) data records, routing data, and maneuver data. In one embodiment, the indexes 713 may improve the speed of data retrieval operations in the database 121. In one embodiment, the indexes 713 may be used to quickly locate data without having to search every row in the database 121 every time it is accessed. For example, in one embodiment, the indexes 713 can be a spatial index of the polygon points associated with stored feature polygons.

In exemplary embodiments, the road segment or link data records 705 are links or segments representing roads, streets, or paths, as can be used in the calculated route or recorded route information for determination of one or more personalized routes. The node data records 703 are end points (such as intersections) corresponding to the respective links or segments of the road segment or link data records 705. The road segment or link data records 705 and the node data records 703 represent a road network, such as used by vehicles, cars, and/or other entities. Alternatively, the database 121 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The database 121 can include data about the POIs and their respective locations in the POI data records 707. The database 121 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the database 121 can also include training data records 709 for storing training data 115, and/or any related data generated or used according to the various embodiments described herein. In one embodiment, the training data 115 can be associated with one or more of the node records 703, road segment records 705, and/or POI data records 707 to associate the training data 115 with specific geographic locations. In this way, the training data 115 can also be associated with the characteristics or metadata of the corresponding records 703, 705, and/or 707.

In one embodiment, the data 700 can also include other data 711 such as data used for evaluating the machine learning model 301. For example, testing dataset that assesses the machine learning model's performance may be stored as the data 711. Additionally, data for tuning and optimizing the machine learning model 301 may be stored as the data 711. For example, data for adjusting the machine learning model's hyperparameters may be stored as the data 711.

In one embodiment, the database 121 can be maintained by the content providers 125 in association with the services platform 123 (e.g., a map developer). The map developer can collect geographic data to generate and enhance the database 121. There can be different ways used by the map developer to collect data. These ways can include obtaining data from other sources, such as municipalities or respective geographic authorities. In addition, the map developer can employ field personnel to travel by vehicle (e.g., vehicle) along roads throughout the geographic region to observe features and/or record information about them, for example. Also, remote sensing, such as aerial or satellite photography, can be used.

The database 121 can be a master geographic database stored in a format that facilitates updating, maintenance, and development. For example, the master geographic database or data in the master geographic database can be in an Oracle spatial format or other spatial format, such as for development or production purposes. Map layers may be utilized. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for assessing impact of traffic spillover may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

The system, apparatus, and methods described herein provide various applications for addressing impact of traffic spillover from a route on a region local to the route, thereby ensuring improved quality of life for population within the region and mitigating adverse impact from the traffic spillover, such as traffic congestion, air pollution, noise pollution, degradation of traffic-related infrastructures, vehicle-related accidents, etc. For example, by providing prediction of adverse impact of traffic spillover of routes on regions local to the routes to drivers, the drivers may be discouraged from traversing alternative routes that go through the regions. Thus, the system, apparatus, and methods described herein provide a technological improvement in traffic management and ADAS features.

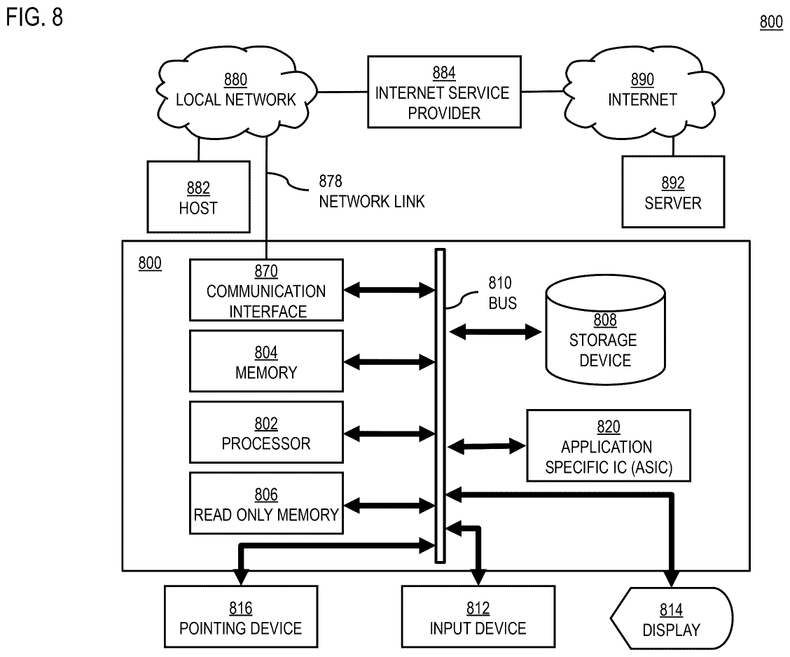

FIG. 8 illustrates a computer system 800 upon which an embodiment of the invention may be implemented. Computer system 800 is programmed (e.g., via computer program code or instructions) to assess impact of traffic spillover as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to assessing impact of traffic spillover. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for assessing impact of traffic spillover. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for assessing impact of traffic spillover, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 1078 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 123 for assessing impact of traffic spillover.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

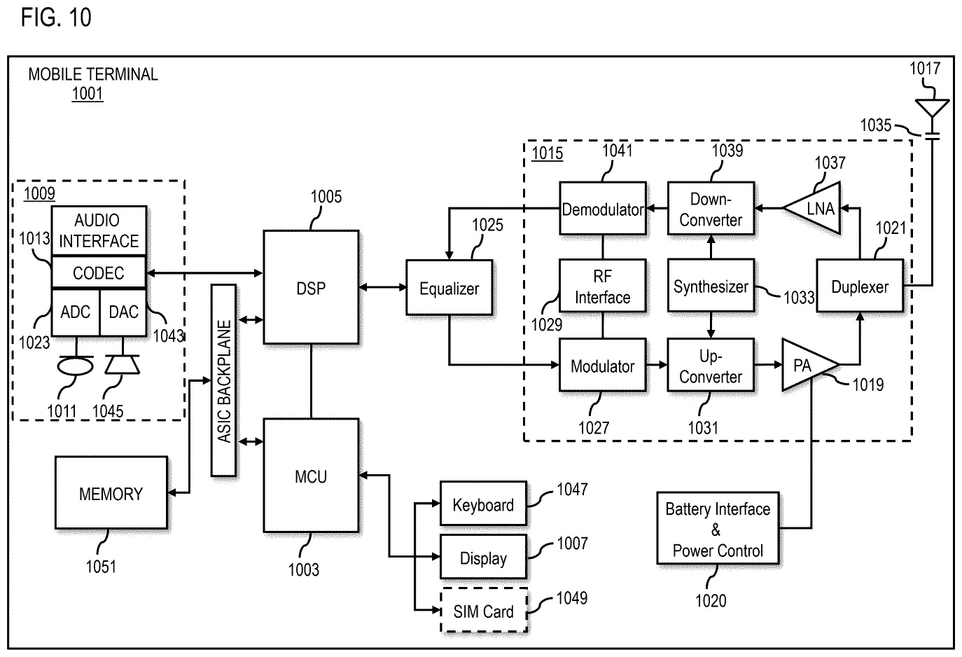

FIG. 9 illustrates a diagram of a chip set 900 upon which an embodiment of the invention may be implemented. Chip set 900 is programmed to assess impact of traffic spillover as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to assess impact of traffic spillover. The memory 905 also stores the data associated with or generated by the execution of the inventive steps.

FIG. 10 illustrates a diagram of exemplary components of a mobile terminal capable of operating in the system of FIG. 1, according to one embodiment. In the illustrated embodiment, a mobile terminal 1000 is provided. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to assess impact of traffic spillover. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An apparatus comprising at least one processor and at least one non-transitory memory including computer program code instructions, the computer program code instructions configured to, when executed, cause the apparatus to:
receive training data indicating events and attributes associated with the events, wherein the events indicate traffic spillover from routes to regions local to the routes;
using the training data, train a machine learning model to predict impact of traffic congestion of a first route on a first region local to the first route based on first attributes associated with the first route;
receive as input the first attributes associated with the first route;
cause the machine learning model to predict the impact based on the first attributes; and
provide the impact as output.

2. The apparatus of claim 1, wherein a functional class of the first route is greater than a functional class of each road segment within the first region.

3. The apparatus of claim 1, wherein the attributes indicate: (i) one or more types of incidents that caused the traffic spillover from the routes; (ii) locations of the incidents on the routes; (iii) a functional class of a road segment in which each of the incidents occurred; (iv) temporal information associated with the events; (v) traffic congestion of the routes and the regions; (vi) weather condition of the routes; (vii) weather conditions of the regions; or (viii) a combination thereof.

4. The apparatus of claim 1, wherein the impact is defined by: (i) a change in traffic congestion within the first region; and (ii) a duration of which the traffic congestion of the first region will be greater than average traffic congestion of the first region.

5. The apparatus of claim 1, wherein the attributes include air quality index (AQI) values of the regions, and wherein the impact indicates an AQI value of the first region.

6. The apparatus of claim 1, wherein the attributes include noise levels of the regions, and wherein the impact indicates a noise level of the first region.

7. The apparatus of claim 1, wherein the computer program code instructions are configured to, when executed, cause the apparatus to, based on the impact, generate a second route that diverges from the first route and terminates at the same destination as the first route.

8. A non-transitory computer-readable storage medium having computer program code instructions stored therein, the computer program code instructions, when executed by at least one processor, cause the at least one processor to:
receive training data indicating events and attributes associated with the events, wherein the events indicate traffic spillover from routes to regions local to the routes;
based on the training data, train a machine learning model to predict impact of traffic congestion of a first route on a first region local to the first route based on first attributes associated with the first route;
receive as input the first attributes associated with the first route;
cause the machine learning model to predict the impact based on the first attributes; and
provide the impact as output.

9. The non-transitory computer-readable storage medium of claim 8, wherein a functional class of the first route is greater than a functional class of each road segment within the first region.

10. The non-transitory computer-readable storage medium of claim 8, wherein the attributes indicate: (i) one or more types of incidents that caused the traffic spillover from the routes; (ii) locations of the incidents on the routes; (iii) a functional class of a road segment in which each of the incidents occurred; (iv) temporal information associated with the events; (v) traffic congestion of the routes and the regions; (vi) weather condition of the routes; (vii) weather conditions of the regions; or (viii) a combination thereof.

11. The non-transitory computer-readable storage medium of claim 8, wherein the impact is defined by: (i) a change in traffic congestion within the first region; and (ii) a duration of which the traffic congestion of the first region will be greater than average traffic congestion of the first region.

12. The non-transitory computer-readable storage medium of claim 8, wherein the attributes include air quality index (AQI) values of the regions, and wherein the impact indicates an AQI value of the first region.

13. The non-transitory computer-readable storage medium of claim 8, wherein the attributes include noise levels of the region, and wherein the impact indicates a noise level of the first region.

14. The non-transitory computer-readable storage medium of claim 8, wherein the computer program code instructions, when executed by the at least one processor, cause the at least one processor to, based on the impact, generate a recommended route that diverges from the first route and terminates at the same destination as the first route.

15. A method comprising:
receiving training data indicating events and attributes associated with the events, wherein the events indicate traffic spillover from routes to regions local to the routes;
based on the training data, training a machine learning model to predict impact of traffic congestion of a first route on a first region local to the first route based on first attributes associated with the first route;
receiving as input the first attributes associated with the first route;
causing the machine learning model to predict the impact based on the first attributes; and
providing the impact as output.

16. The method of claim 15, wherein a functional class of the first route is greater than a functional class of each road segment within the first region.

17. The method of claim 15, wherein the attributes indicate: (i) one or more types of incidents that caused the traffic spillover from the routes; (ii) locations of the incidents on the routes; (iii) a functional class of a road segment in which each of the incidents occurred; (iv) temporal information associated with the events; (v) traffic congestion of the routes and the regions; (vi) weather condition of the routes; (vii) weather conditions of the regions; or (viii) a combination thereof.

18. The method of claim 15, wherein the impact is defined by: (i) a change in traffic congestion within the first region; and (ii) a duration of which the traffic congestion of the first region will be greater than average traffic congestion of the first region.

19. The method of claim 15, wherein the attributes include air quality index (AQI) values of the regions, and wherein the impact indicates an AQI value of the first region.

20. The method of claim 15, wherein the attributes include noise levels of the region, and wherein the impact indicates a noise level of the first region.
